(19) United States
(12) Patent Application Publication
(10) Pub. No.: US 2020/0302463 A1
(43) Pub. Date: Sep. 24, 2020

(54) Method of Using Savings and Investments to Promote Transactions Between Consumers and Vendors with Incentives

(71) Applicant: Sreejita Saha, Kolkata (IN)

(72) Inventor: Sreejita Saha, Kolkata (IN)

(21) Appl. No.: 16/896,005

(22) Filed: Jun. 8, 2020

Related U.S. Application Data
(63) Continuation-in-part of application No. PCT/IB2018/059789, filed on Dec. 7, 2018.
(60) Provisional application No. 62/595,923, filed on Dec. 7, 2017.

(51) Int. Cl. G06Q 30/02; G06Q 40/02; G06Q 20/08; G06Q 20/10; G06Q 40/06

(52) U.S. Cl. CPC G06Q 30/0213; G06Q 40/02; G06Q 10/087; G06Q 20/108; G06Q 40/06; G06Q 20/0855

(57) ABSTRACT

A method of using savings and investments to promote transactions between consumers and vendors with incentives provides a plurality of client accounts and a plurality of vendor accounts. At least one qualified client account is chosen from the plurality of client accounts and a first set of financial actions is tracked. The first set of financial actions is compared with an inventory list of each vendor account to determine at least one preferred vendor account. The guaranteed sales amount is determined between the qualified client account and the preferred vendor account. If the value of the transactions between the qualified client account and the preferred vendor account is below the guaranteed sales amount, then a remainder amount is financially transferred from the qualified client amount to the preferred vendor account.

The current application is a continuation-in-part (CIP) application of the Patent Cooperation Treaty (PCT) application PCT/IB2018/059789 filed on Dec. 7, 2018. The PCT application PCT/IB2018/059789 claims a priority to the U.S. Provisional Patent application Ser. No. 62/595,923 filed on Dec. 7, 2017.

### FIELD OF THE INVENTION

The present invention generally relates to a method and system for using savings and investments to guarantee sales for retailers, online service providers, insurers, financial institutions by analyzing expenditure patterns. More specifically, the present invention incentivizes consumers to purchase a minimum amount of goods and services from vendors.

### BACKGROUND OF THE INVENTION

Banks and financial institutions have helped people save and invest their earnings for hundreds of years. People usually keep their earnings in a savings, checking, money market, CD, IRA, a deposit account, or a transactional account. These accounts provide a convenient way for people to save, invest, as well as spend their earning using direct debit facility, debit cards, cash withdrawn etc. Credit cards linked to the savings account usually have set limits based on many factors such as spending patterns, credit history, etc.

Benefits and incentives are also known in the prior art to be used in conjunction with saving and current accounts. Savings accounts are known to have several incentives to attract and retain users. For example, some saving accounts offer interest that is paid on the amount kept in the account whereas others don't pay any interest at all. Some accounts allow overdraft facilities. Some accounts such as Interest Saving Accounts in the United Kingdom offer tax incentives as well.

Further, it known in the relevant arts, that debit cards and credit cards give incentives based on the amount of money spent by the users. These incentives usually come in the form of cash, points, or miles. For example, many credit cards offer cash which can in turn be used to reduce the credit card balance. Further, many cards offer frequent flyer miles and additional benefits such as access to lounge and excess baggage allowance when flight tickets are bought using those credit cards from companies they have tied up with. Further yet, many cards use point rewards on each dollar spent, that can be redeemed with participating retailers. Such incentive schemes encourage shopping with particular retailers, service providers and financial institutions leading to higher revenue for them and higher transaction usage and fees of credit and debit cards. Other goals include discounts to encourage people to try out new products and form new consumer habits.

An individual can have numerous saving and current accounts, debit cards and credit cards with different banks. The data like debits, credits and balance associated with these accounts were only accessible to banks with whom the account, debit card and credit card was, and they often shared it with credit bureaus. With Second Payment Services Directive in the EU allowing for access to bank data on client consent through standard Application programming interface (APIs) and technologies such as data scraping bank and other financial account data can be made available to third parties as well.

### SUMMARY OF THE INVENTION

The present invention is a method and system for using savings and investments to guarantee sales of different items with retailers, online service providers, insurers, financial institutions and other service providers by analyzing expenditure patterns of clients. Clients with savings accounts are incentivized to spend a certain amount of their earnings on preferred vendor in return for lower costs and discounts. In return for providing incentives, vendors such as retailers, online service providers, insurers, financial institutions and other service providers are guaranteed sales of their goods and services. As such, the vendors benefit from lower volatility in revenue and higher customer loyalty. In addition, the method and system permit retailers, online service providers, insurers, financial institutions and other service providers to easily store, modify, offer, track and administer the incentive programs embodied within the present invention.

### BRIEF DESCRIPTION OF THE DRAWINGS

FIG. 1 is a block diagram of the system of the present invention.

FIG. 2 is a flowchart of the general process of the present invention.

FIG. 3 is a flowchart illustrating the subprocess for selecting a qualified client account from the plurality of client accounts.

FIG. 4 is a flowchart illustrating the subprocess for determining the value of the guaranteed sales amount with the corresponding PC device.

FIG. 5 is a flowchart illustrating the subprocess for determining the value of the guaranteed sales amount with the remote server.

FIG. 6 is a flowchart illustrating the subprocess for identifying at least one desired entry and the at least one desired incentive.

FIG. 7 is a flowchart illustrating the subprocess for applying a lien on the qualified client account.

FIG. 8 is a flowchart illustrating the subprocess for determining the actual amount spent by qualified client account.

FIG. 9 is a flowchart illustrating the subprocess for removing the lien is the qualified client account is eligible for extenuating circumstances.

### DETAILED DESCRIPTION OF THE INVENTION

All illustrations of the drawings are for the purpose of describing selected versions of the present invention and are not intended to limit the scope of the present invention.

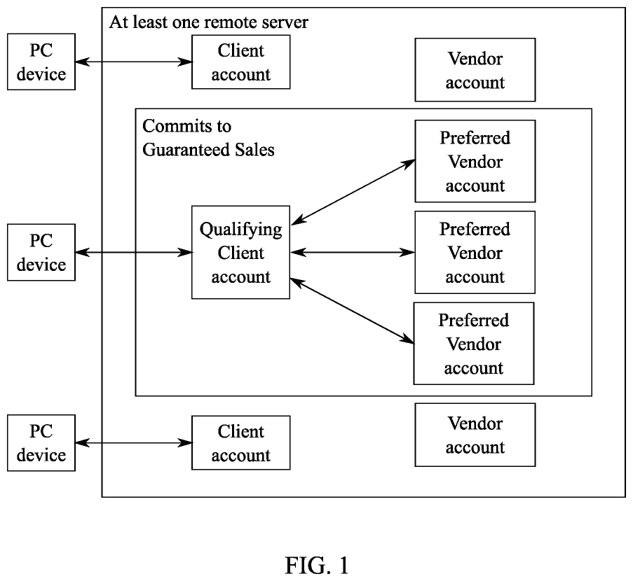

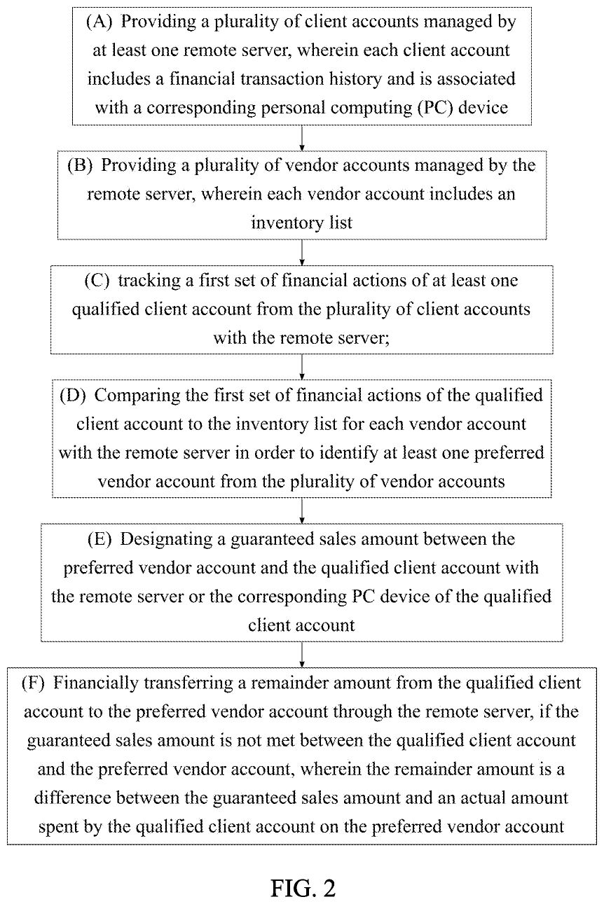

The present invention is a system and method of encouraging economic activity between consumers with savings and investments and vendors such as retailers, online service providers, insurers, financial institutions, and/or the like. In particular, the present invention actively promotes goods and services offered by the vendors to increase financial transactions between the consumers and the vendors. Referring to FIG. 1 and FIG. 2, in the preferred embodiment of the present invention, a plurality of client accounts managed by at least one remote server is provided, wherein each client account includes a financial transaction history and is associated with a corresponding personal computing (PC) device (Step A). Preferably the PC device acts as a terminal for collecting data from a consumer and transmitting data to the remote server. The PC device includes, but is not limited to, smartphones, laptops, desktops, personal digital assistants (PDAs), smartwatches, and the like. The at least one remote server may be a monolithic or distributed computing system responsible for storing, processing, and outputting data about each client account. In one possible embodiment, the data may be collected directly from the corresponding PC device of each client account. In another possible embodiment, the data from the corresponding PC device may be relayed to the remote server through one or more secondary remote servers. In addition to the plurality of client accounts, a plurality of vendor accounts managed by the remote server is provided, wherein each vendor account includes an inventory list (Step B). The plurality of vendor accounts allows a vendor to promote goods and services to the plurality of client accounts and the associated consumer. The vendor includes, but is not limited to, retailers, online service providers, insurers, financial institutions and other service providers. Preferably, a detailed list of goods and services provided by the vendor is recorded into the inventory list. Further, the remote server also allows the plurality of vendor accounts to track and administer the incentive related to the goods and services.

Subsequently, the remote server tracks a first set of financial actions of at least one qualified account from the plurality of client accounts (Step C). In one possible embodiment, the qualified client account is a client account with a first set of financial actions that meet or exceed a pre-set threshold. The first set of financial actions may include how much money is disbursed from the qualified account over a period of time such as a year, on different items such as groceries, clothing, medicines, cosmetics, jewelry, internet advertisements, telephone providers, electricity bills, entertainment, online shopping, daily transportation, flight tickets, hotel stays, insurance covers and with different retailers, service providers and financial institutions. Based on the first set of financial actions, the remote server selects at least one vendor account that offers services suited to the needs of the qualified account. It should be noted that “at least one” signifies more than one instance of an object. As such, the at least one qualified client account may include a plurality of qualified client accounts.

Accordingly, the remote server compares the first set of financial actions of the qualified client account to the inventory list of each vendor account, in order to identify at least one preferred vendor account from the plurality of vendor accounts (Step D). Similar to the qualified client account, the at least one preferred vendor account may be a plurality of preferred vendor accounts. Once the preferred vendor account is determined, the remote server actively promotes goods and services from the inventory list to the qualified client account. This may be achieved by actively sending incentives such as cashbacks, discounts, bonus points and the like from the preferred vendor account to the qualified client account. Accordingly, a guaranteed sales amount between the preferred vendor account and the qualified client account is designated using the remote server or the corresponding PC device (Step E). In an embodiment with a plurality of preferred vendor accounts, the guaranteed sales amount may be value of all of the goods and services marketed by the plurality of preferred vendor accounts. For example, the guaranteed sales amount may be $10,000 annually from a plurality of preferred vendor accounts such as Home Depot and Walgreen. In another possible embodiment, the qualified client account may be prompted to enter an amount which the corresponding consumer is willing to spend via the corresponding PC device. In another possible embodiment, the remote server may utilize an algorithm to determine an amount the qualified client account is likely to spend depending on the first set of financial actions. In both of these embodiments, the value that is generated is designated as the guaranteed sales amount.

In one possible embodiment, the qualified client account and the preferred vendor account are both prompted to commit to purchasing and providing incentives to and from each other. Once the qualified client account and the preferred vendor account commit to the purchasing and providing incentives, the remote server actively promotes goods and services on the inventory list of the preferred vendor account to the qualified client account. To ensure that the qualified client account spends the guaranteed sales amount, the qualified client account must purchase goods and services equivalent in value to the guaranteed sales amount, else the remote server will deduct the difference in value. Accordingly, the remote server financially transfers a remainder amount from the qualified client account to the preferred vendor account, if the guaranteed sales amount is not met between the qualified client account and the preferred vendor account, wherein the remainder amount is a difference between the guaranteed sales amount and an actual amount spent by the qualified client account on the preferred vendor account (Step F). it should be noted that Steps A-F are the general processes of the present invention. The following paragraphs describes detailed subprocesses of the general processes that may be included in selected embodiments of the present invention.

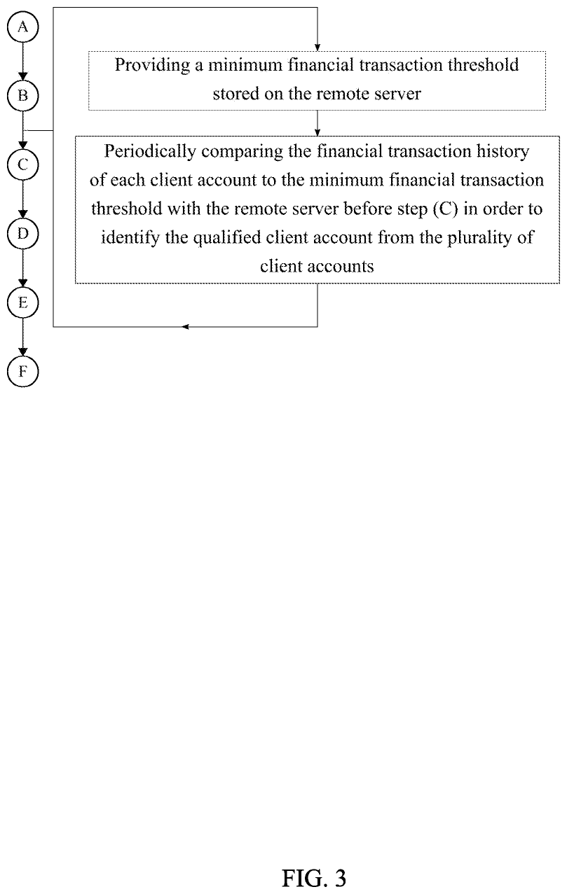

Referring to FIG. 3, in one possible embodiment, the remote server filters the at least one qualified client account from the plurality of a client accounts by the amount of savings and investments in the qualified client account. As such, a minimum financial transaction threshold stored on the remote server is provided. As such, the remote server periodically compares the financial transaction history of each client account to the minimum financial transaction threshold before Step C, in order to identify at least one qualified client account from the plurality of client accounts. Financial transactions history refers to savings and investments of the corresponding client account. Similarly, the minimum financial transaction threshold may be the minimum value of the savings and/or investments of the corresponding client account. Accordingly, the at least one qualified client account is designated as the client account with savings and investments that meets or exceeds the minimum financial transaction threshold. It should be noted that “at least one” signifies more than one instance of an object. As such, the at least one qualified client account may include a plurality of qualified client accounts.

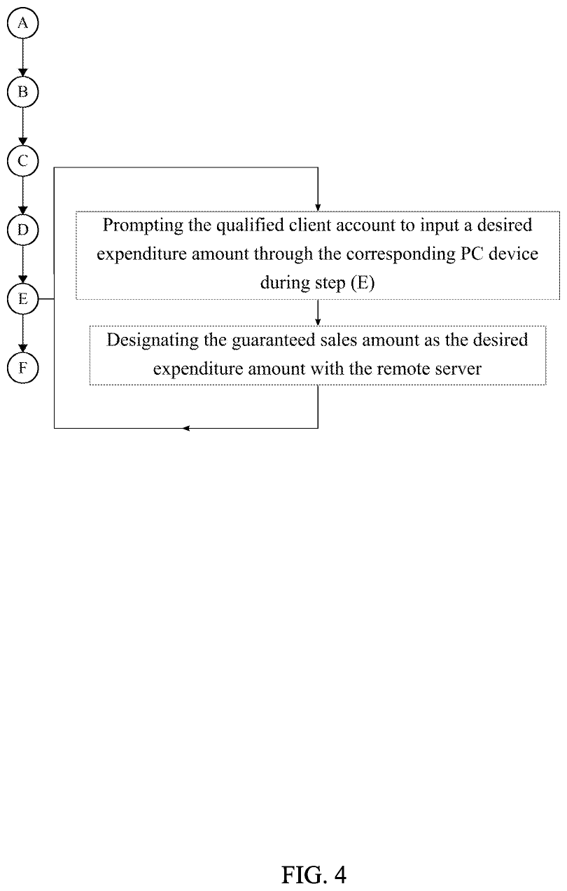

Referring to FIG. 4, as mentioned, the guaranteed sales amount may be user generated or derived by the remote server. For example, in one possible embodiment, the corresponding PC device prompts the qualified client account to input a desired expenditure amount during Step E. More specifically, the remote server may prompt the qualified client account via the corresponding PC device. Subsequently, the remote server designates the guaranteed sales amount as the desired expenditure amount. This gives the consumer using the qualified client account some degree of freedom as to the amount he or she is willing to spend.

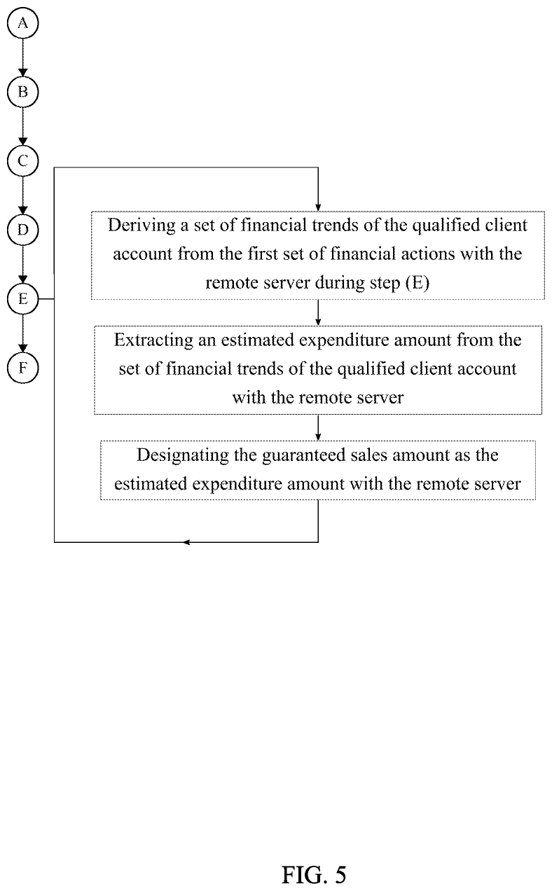

Referring to FIG. 5, in another possible embodiment of the present invention, the remote server automatically determines the guaranteed sales amount using the first set of financial actions. Accordingly, the remote server derives a set of financial trends of the qualified client account from the first set of financial actions. More specifically, the first set of financial actions includes expenditure patterns collected and aggregated over a period of time such as a year. This allows the remote server to analyze and predict future expenditures of the qualified client account. As such, the set of financial trends is derived using data analytics on the expenditure patterns to predict future value of the savings and/or investments of the qualified client account. Subsequently, the remote server extracts an estimated expenditure amount from the set of financial trends of the qualified client account. Finally, the remote server designates the guaranteed sales amount as the estimated expenditure amount. By using predictive data analytics to determine the guaranteed sales amount, there is a high probability that the expenditures of the qualified client account will meet or exceed the guaranteed sales amount. Thus, this minimizes the chances of the qualified client account being deducted the remainder amount in Step F. In some embodiments of the present invention, the estimated expenditure amount is displayed with the corresponding PC device of the qualified client account so that the qualified client account can either accept or deny designating the estimated expenditure amount as the guaranteed sales amount. If the qualified client account denies designating the estimated expenditure amount as the guaranteed sales amount, then the qualified client account can enter a counteroffer amount that can instead be designated as the guaranteed sales amount. The counteroffer amount should be within a reasonable range of the estimated expenditure amount and is dependent on the personal user preferences of the qualified client account.

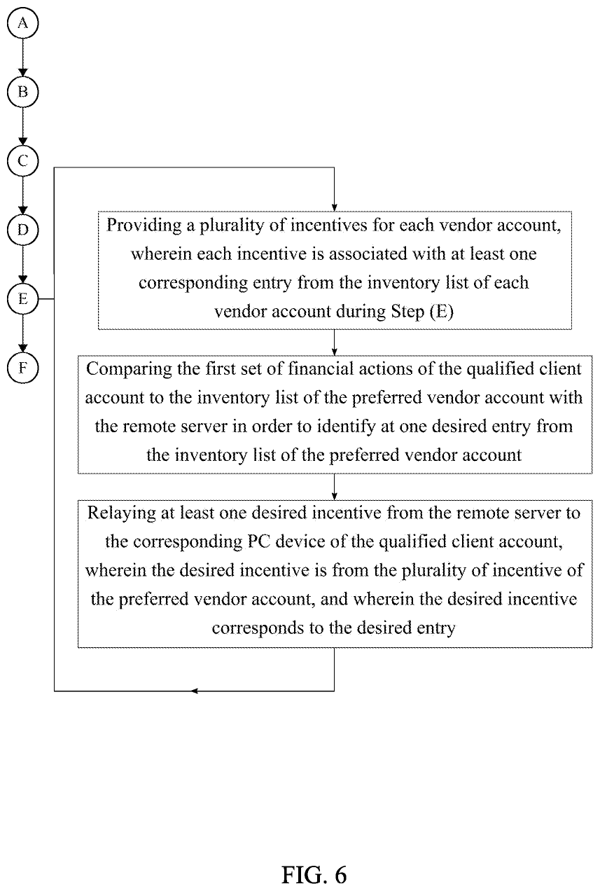

Referring to FIG. 6, in one possible embodiment, the principle method of promoting and notifying the qualified client account of the goods and services offered by the preferred vendor account is through coupons and vouchers. Preferably, a plurality of incentives is provided for each vendor account, wherein each incentive is associated with at least one corresponding entry from the inventory list of each vendor account. The plurality of incentives includes, but is not limited to, cashbacks, discounts, and customer loyalty programs. Each incentive is related to an entry in the inventory list. As such, the remote server compares the first set of financial actions of the qualified client account to the inventory list of the preferred vendor account, in order to identify at one desired entry from the inventory list of the preferred vendor account. More specifically, the remote server analyzes the expenditure patterns included in the first set of financial actions to optimize the at least one desired entry for the time of year, historical spending rates, and/or expending trends of the qualified client account. For example, if it is near the holiday season, the remote server may select popular gift items as the desired entry. In addition, the remote server may also utilize external data sources not related to the qualified client account, such as the buying patterns of the general public, to identify the desired entry.

Subsequently, the remote server relays at least one desired incentive to the corresponding PC device of the qualified client account, wherein the desired incentive is from the plurality of incentives of the preferred vendor account, and wherein the desired incentive corresponds to the desired entry. Accordingly, the desired incentive may offer discounts, cashback, special deals, or coupons for the desired entry, thus incentivizing consumer of the qualified client account to make the purchase. In selected embodiments of the present invention, the desired incentive may be delivered through mobile barcodes, digital vouchers, coupons, loyalty cards, that appear in the corresponding PC device. Alternately, the physical vouchers, coupons, and or loyalty cards may also be mailed to the consumer of the qualified client account. It should be noted that “at least one” as herein used, refers to more than one instance of an object. Thus, at least one desired entry and the at least one desired incentive may be a plurality of desired entries with a plurality of desired incentives in selected embodiments.

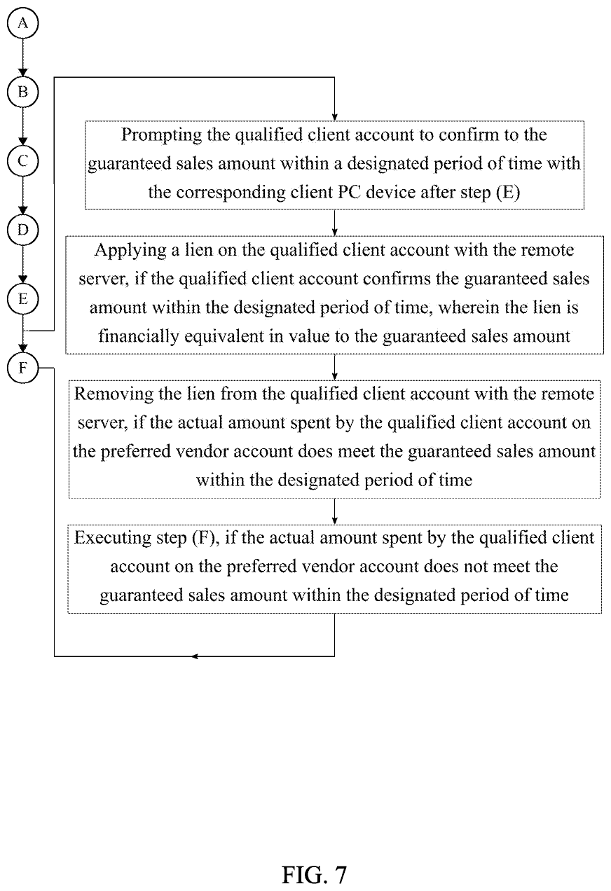

Referring to FIG. 7, in one possible embodiment, a lien is placed on the qualified client account to incentivize the corresponding consumer to meet the guaranteed sales amount. As previously mentioned, the guaranteed sales amount may be either manually inputted through the corresponding PC device or automatically derived by the remote server. In this embodiment, the qualified client device is required to agree to the guaranteed sales amount. Accordingly, the corresponding PC device prompts the qualified client account to confirm to the guaranteed sales amount within a designated period of time after step E. The designated period of time may be a month, half-a-year, or a year depending on the value of the guaranteed sales amount. The transactions between the qualified client account and the preferred vendor account must meet or exceed the guaranteed sales amount within the designated period of time. As such, the remote server applies a lien on the qualified client account, if the qualified client account confirms the guaranteed sales amount within the designated period of time, wherein the lien is financially equivalent in value to the guaranteed sales amount.

The lien gives the remote server the ability to deduct the remainder amount from the qualified client account if the guaranteed sales amount is not met. Consequently, Step F is executed, if the actual amount spent by the qualified client account on the preferred vendor account does not meet the guaranteed sales amount within the designated period of time. Alternately, the remote server removes the lien from the qualified client account with the remote server, if the actual amount spent by the qualified client account on the preferred vendor account does meet the guaranteed sales amount within the designated period of time. This ensures that the preferred vendor account receives the revenues equal to the guaranteed sales amount.

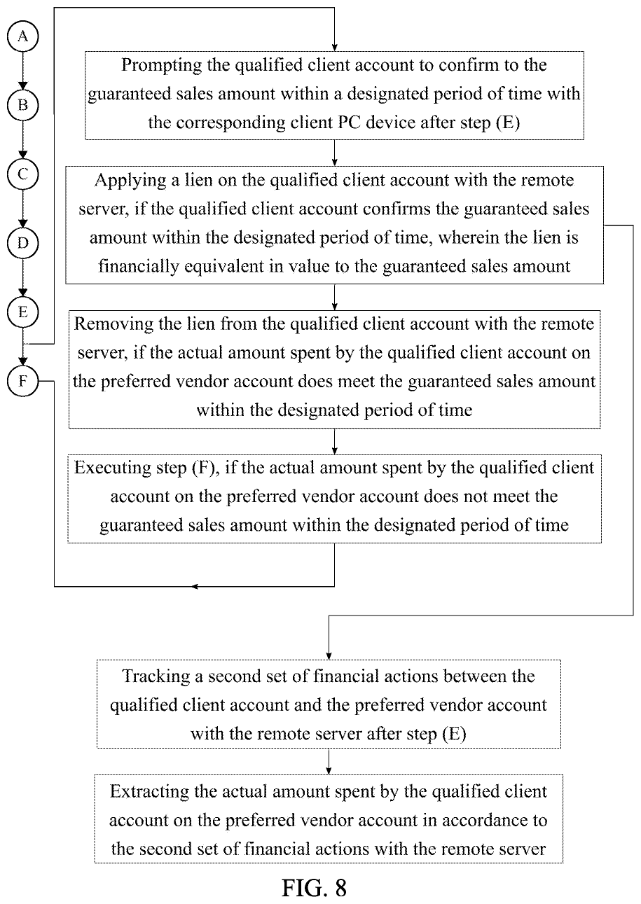

Referring to FIG. 8, in this embodiment, the remote server tracks the activity of the qualified client account for the designated time period for the disbursal of the guaranteed sales amount. As such, the remote server tracks a second set of financial actions between the qualified client account and the preferred vendor account after Step E. The second set of financial actions may be the expenditure history of the qualified client account over the designated period of time. In one possible embodiment, the second set of financial actions may be extracted directly from the corresponding PC device through well-known techniques such as data-scraping. In another possible embodiment, the qualified client account may be linked to a bank account managed by a third-party financial institution in order to track the second set of financial actions. This allows the consumer of the qualified client account to link his or her bank accounts, debit cards, credit cards as allowed by the second payment services directive in the European Union (EU) through standard Application programming interface (API). In another possible embodiment, the second set of financial actions could be tracked by receiving real-time information from a customized database of the preferred vendor account. The customized database is used to record all of the purchases made by the qualified client account from the preferred vendor account and can be accessed by the remote server at any time. In another possible embodiment, the second set of financial actions could be tracked through a loyalty program for the preferred vendor account. The loyalty program manages and tracks the rewards, credits, points, etc. earned by the qualified client account with the purchases made from the preferred vendor account. Finally, the remote server extracts the actual amount spent by the qualified client account on the preferred vendor account in accordance to the second set of financial actions. More specifically, the remote server may calculate the amount disbursed from the qualified client account to the preferred vendor account to determine the actual amount spent. This gives the remote server the ability to decide on executing the lien.

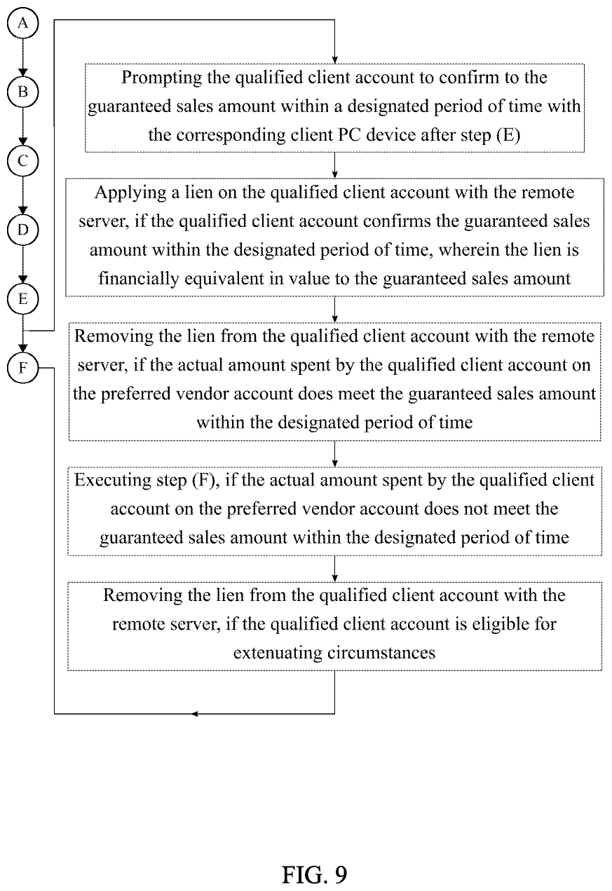

Referring to FIG. 9, in this embodiment, the qualified client account is excluded from having to the meet the guaranteed sales amount if the consumer experiences a fall in income, a health emergency, and a distant relocation (e.g. to a different country). As such, the remote server removes the lien from the qualified client account, if the qualified client account is eligible for extenuating circumstances. This happens regardless of whether the qualified client account meets or fails to meet the guaranteed sales amount. This prevents the consumer from spending when he or she is uncomfortable or incapable doing so. Extenuating circumstances may be when the consumer become unemployed, experienced major health related expenses, or dies. This information may be collected through the corresponding PC device or another method.

Although the invention has been explained in relation to its preferred embodiment, it is to be understood that many other possible modifications and variations can be made without departing from the spirit and scope of the invention as hereinafter claimed.

What is claimed is:

1. A method of using savings and investments to promote transactions between consumers and vendors with incentives comprises:
(A) providing a plurality of client accounts managed by at least one remote server, wherein each client account includes a financial transaction history and is associated with a corresponding personal computing (PC) device;
(B) providing a plurality of vendor accounts managed by the remote server, wherein each vendor account includes an inventory list;
(C) tracking a first set of financial actions of at least one qualified client account from the plurality of client accounts with the remote server;
(D) comparing the first set of financial actions of the qualified client account to the inventory list for each vendor account with the remote server in order to identify at least one preferred vendor account from the plurality of vendor accounts;
(E) designating a guaranteed sales amount between the preferred vendor account and the qualified client account with the remote server or the corresponding PC device of the qualified client account; and
(F) financially transferring a remainder amount from the qualified client account to the preferred vendor account through the remote server, if the guaranteed sales amount is not met between the qualified client account and the preferred vendor account, wherein the remainder amount is a difference between the guaranteed sales amount and an actual amount spent by the qualified client account on the preferred vendor account.

2. The method of using savings and investments to promote transactions between consumers and vendors with incentives as claimed in claim 1 comprises:
providing a minimum financial transaction threshold stored on the remote server; and
periodically comparing the financial transaction history of each client account to the minimum financial transaction threshold with the remote server before step (C) in order to identify the qualified client account from the plurality of client accounts.

3. The method of using savings and investments to promote transactions between consumers and vendors with incentives as claimed in claim 1 comprises:
prompting the qualified client account to input a desired expenditure amount through the corresponding PC device during step (E); and
designating the guaranteed sales amount as the desired expenditure amount with the remote server.

4. The method of using savings and investments to promote transactions between consumers and vendors with incentives as claimed in claim 1 comprises:
deriving a set of financial trends of the qualified client account from the first set of financial actions with the remote server during step (E);
extracting an estimated expenditure amount from the set of financial trends of the qualified client account with the remote server; and
designating the guaranteed sales amount as the estimated expenditure amount with the remote server.

5. The method of using savings and investments to promote transactions between consumers and vendors with incentives as claimed in claim 1 comprises:
providing a plurality of incentives for each vendor account, wherein each incentive is associated with at least one corresponding entry from the inventory list of each vendor account;
comparing the first set of financial actions of the qualified client account to the inventory list of the preferred vendor account with the remote server, in order to identify at one desired entry from the inventory list of the preferred vendor account; and
relaying at least one desired incentive from the remote server to the corresponding PC device of the qualified client account, wherein the desired incentive is from the plurality of incentives of the preferred vendor account, and wherein the desired incentive corresponds to the desired entry.

6. The method of using savings and investments to promote transactions between consumers and vendors with incentives as claimed in claim 1 comprises:
prompting the qualified client account to confirm to the guaranteed sales amount within a designated period of time with the corresponding client PC device after step (E);
applying a lien on the qualified client account with the remote server, if the qualified client account confirms the guaranteed sales amount within the designated period of time, wherein the lien is financially equivalent in value to the guaranteed sales amount;
removing the lien from the qualified client account with the remote server, if the actual amount spent by the qualified client account on the preferred vendor account does meet the guaranteed sales amount within the designated period of time; and
executing step (F), if the actual amount spent by the qualified client account on the preferred vendor account does not meet the guaranteed sales amount within the designated period of time.

7. The method of using savings and investments to promote transactions between consumers and vendors with incentives as claimed in claim 6 comprises:
tracking a second set of financial actions between the qualified client account and the preferred vendor account with the remote server after step (E); and
extracting the actual amount spent by the qualified client account on the preferred vendor account in accordance to the second set of financial actions with the remote server;

8. The method of using savings and investments to promote transactions between consumers and vendors with incentives as claimed in claim 6 comprises:
removing the lien from the qualified client account with the remote server, if the qualified client account is eligible for extenuating circumstances.
